(19) United States
(12) Patent Application Publication
(10) Pub. No.: US 2019/0145022 A1
(43) Pub. Date: May 16, 2019

(54) DEVICES AND METHODS FOR PRODUCING ALIGNED NANOFIBERS

(71) Applicant: ROWAN UNIVERSITY, Glassboro, NJ (US)

(72) Inventors: DAVE JAO, GLASSBORO, NJ (US); VINCE BEACHLEY, GLASSBORO, NJ (US)

(21) Appl. No.: 16/191,254

(22) Filed: Nov. 14, 2018

Related U.S. Application Data
(60) Provisional application No. 62/586,648, filed on Nov. 15, 2017.

(51) Int. Cl. D01D 5/16; D01D 5/098; D01D 5/38; D01D 10/04

(52) U.S. Cl. CPC D01D 5/16; D01D 5/098; B82Y 40/00; D01D 10/0445; D01D 10/0463; D01D 5/38

(57) ABSTRACT

The invention provides systems and methods for forming nanofibers and nanofiber arrays in a continuous and efficient manner, without the use of electrospinning. In certain embodiments, the systems and methods allow for simultaneous pulling and elongation of the nanofibers through the use of two rotating belts.

### CROSS-REFERENCE TO RELATED APPLICATIONS

This application claims priority under 35 U.S.C. § 119(e) to U.S. Provisional Application No. 62/586,648, filed Nov. 15, 2017, which application is hereby incorporated herein by reference in its entirety.

### STATEMENT REGARDING FEDERALLY SPONSORED RESEARCH OR DEVELOPMENT

This invention was made with government support under grant number NSF1561966 & NSF1653329 awarded by The National Science Foundation and grant number W911NF-17-2-0227 awarded by Army Research Laboratory. The government has certain rights in the invention.

### BACKGROUND OF THE INVENTION

Nanofibers can be used in a number of fields for a wide range of applications, including filtration technologies, textiles, battery and fuel cell technologies, and biosensors. There is a growing interest in efficient and economical methods and devices for manufacturing nanofibers composed of a wide range of materials. However, the accessibility of nanofiber materials is limited because production of polymer nanofibers is generally very difficult using conventional techniques. Previously established electrospinning methods require an applied voltage and have limited applicability, because they cannot be used with polymer solutions that have high viscosity, poor solubility or low electrical conductivity. Other methods that utilize mechanical stretching, such as “hand-stretching” or “hand-pulling” processes to manually stretch polymers into nanofibers are also limited in scope, because they do not allow for high throughput and continuous production.

There is thus a need in the art for devices and methods for producing aligned nanofibers. Such devices and methods should be applicable to a range of polymer materials, be energy efficient, and allow for continuous, automated production. The present invention addresses and meets these needs.

### BRIEF SUMMARY OF THE INVENTION

The invention provides a system for forming a nanofiber.

In certain embodiments, the system comprises a first automated track apparatus comprising a first rotating belt spanning at least one first roller. In certain embodiments, the system comprises a first automated track apparatus comprising a first rotating belt spanning at least two first rollers. In certain embodiments, the system comprises a second automated track apparatus comprising a second rotating belt spanning at least two second rollers. In certain embodiments, the system comprises a second automated track apparatus comprising a second rotating belt spanning at least one second roller. In certain embodiments, the system comprises a vessel containing a nanofiber precursor material. In certain embodiments, the track is kept at room temperature. In certain embodiments, the track is heated to a temperature above room temperature, such as about 30° C., about 40° C., about 50° C., about 60° C., about 70° C., about 80° C., about 90° C., about 100° C., or higher than about 1000° C. In certain embodiments, the track is heated to a temperature above room temperature, such as about 30° C., about 40° C., about 50° C., about 60° C., about 70° C., about 80° C., about 90° C., about 100° C., or higher than about 100° C. In certain embodiments, the track is cooled to a temperature below room temperature, such as about 20° C., about 10° C., about 0° C., about −10° C., about −20° C., or lower than about −20° C.

In certain embodiments, the first rotating belt and the second rotating belt are disposed facing each other and define a contact point where the first rotating belt and the second rotating belt are in contact with each other or are at their closest point to each other.

In certain embodiments, the first rotating belt, second rotating belt and contact point define an internal cavity where the first rotating belt and second rotating belt face each other at a distance from each other.

In certain embodiments, the first automated track apparatus is adapted and configured to rotate the first rotating belt around the at least one (or two) first rollers. In certain embodiments, the second automated track apparatus is adapted and configured to rotate the second rotating belt around the at least one (or two) second rollers. In certain embodiments, the first rotating belt and the second rotating belt move in the same direction away from the contact point, towards the internal cavity.

In certain embodiments, the vessel is adapted and configured to deliver the nanofiber precursor material to the contact point and the first rotating belt and the second rotating belt are adapted and configured to contact the nanofiber precursor material at the contact point such that the nanofiber precursor material adheres to the first rotating belt and the second rotating belt, such that the nanofiber precursor material spans from the first rotating belt to the second rotating belt.

In certain embodiments, the vessel does not comprise an electrospinning nozzle.

In certain embodiments, the nanofiber precursor material is not an electrospun material.

In certain embodiments, when the first rotating belt and second rotating belt move away from the contact point, the nanofiber precursor material is carried into the internal cavity and is elongated while moving through the internal cavity, thereby forming a nanofiber.

In certain embodiments, the angle defined by the first automated track apparatus, the contact point and the second automated track apparatus ranges from 0° to about 180°.

In certain embodiments, the vessel comprises a nozzle adapted and configured to deliver the nanofiber precursor material to the contact point through a method selected from the group consisting of dripping, spraying, pouring, brushing, electrospraying, and injecting.

In certain embodiments, the vessel and nozzle define a vertical axis aligned perpendicularly to the ground, wherein the contact point is aligned along the vertical axis, directly below the nozzle.

In certain embodiments, the vessel and nozzle are adapted and configured to deliver the nanofiber precursor material to the contact point by delivering the nanofiber precursor material to the first rotating belt, the second rotating belt or both, at a point “upstream” from the contact point, such that the nanofiber precursor material is carried to the contact point as the first and second rotating belts move.

In certain embodiments, the vessel is a reservoir adapted and configured to allow the first rotating belt, second rotating belt or both, to contact the nanofiber precursor material such that an amount of nanofiber precursor material adheres to the rotating belt and carries it to the contact point as the first and second rotating belts move.

In certain embodiments, the system further comprises a collection rack disposed within the internal cavity, distal to the contact point, adapted and configured to remove the nanofiber from the first and second rotating belts.

In certain embodiments, the distance between the first rotating belt and the second rotating belt at the point where the collection rack removes the nanofiber is greater than about 1 cm.

In certain embodiments, the first automated track apparatus and the second automated track apparatus are belt driven systems powered by a motor.

In certain embodiments, the first automated track apparatus and the second automated track apparatus are manually operated belt driven systems.

In certain embodiments, the first rotating belt is driven by the at least one first roller.

In certain embodiments, the first rotating belt is driven by at least one of the at least two first rollers.

In certain embodiments, the second rotating belt is driven by at least one second roller.

In certain embodiments, the second rotating belt is driven by at least one of the at least two second rollers.

In certain embodiments, at least one parameter of the first automated track apparatus and the second automated track apparatus selected from the group consisting of the rotating belt movement speed, rotating belt orientation and rotating belt location are independently modifiable.

In certain embodiments, the first rotating belt and the second rotating belt both move at a speed ranging from about 0.1 cm/min and about 3 m/s.

In certain embodiments, the first rotating belt and the second rotating belt both move at a speed ranging from about 0.5 cm/min and about 100 cm/min.

In certain embodiments, the first rotating belt and the second rotating belt independently comprise at least one material selected from the group consisting of rubber, plastic, ceramics, and metals.

In certain embodiments, the first rotating belt and the second rotating belt each independently have a patterned textured surface independently selected from the group consisting of sponges, holes, brushes, bristles, and pillars.

In certain embodiments, the vessel comprises a centrifugal spinning apparatus adapted and configured to rotate and extrude nanofiber precursor material towards the contact point between the first rotating belt and the second rotating belt.

In certain embodiments, the centrifugal spinning system is oriented such that the rotational axis of the centrifugal spinning system is oriented vertically.

The invention further comprises a method of forming a nanofiber. In certain embodiments, the method comprises contacting a nanofiber precursor to a contact point defined by a first rotating belt and a second rotating belt, the contact point being where the first rotating belt and the second rotating belt are in contact or are nearly in contact, wherein the nanofiber precursor adheres to both the first rotating belt and the second rotating belt. In certain embodiments, the method comprises moving the first rotating belt and the second rotating belt such that the nanofiber precursor is moved away from the contact point and into an internal cavity defined by the contact point, the first rotating belt and the second rotating belt, wherein the nanofiber precursor forms a linear nanofiber having one end adhered to the first rotating belt and the opposite end adhered to the second rotating belt.

In certain embodiments, the nanofiber precursor is not electrospun.

In certain embodiments, the first rotating belt, the contact point and the second rotating belt are disposed such that they form an angle greater than 0° and the linear nanofiber is elongated and stretched as it moves through the internal cavity.

In certain embodiments, the nanofiber precursor is delivered to the contact point from a vessel comprising the nanofiber precursor by a method selected from the group consisting of dripping, spraying, pouring, brushing, electrospraying, and injecting.

In certain embodiments, the linear nanofiber is deposited on a collection rack disposed within the internal cavity.

In certain embodiments, the method is repeated in order to form two or more nanofibers.

In certain embodiments, the method is a continuous method whereby nanofibers are produced in a continuous manner.

In certain embodiments, the linear nanofibers are deposited on a collection rack disposed within the internal cavity, such that the deposited nanofibers are aligned with one another.

In certain embodiments, the linear nanofibers are deposited on a collection rack disposed within the internal cavity, such that the deposited nanofibers are deposited to form an array having a desired geometry.

In certain embodiments, the nanofiber precursor is a material selected from the group consisting of polymer solutions, polymer melts that includes any polymer that can be dissolved into a solution or melted to a moldable state.

In certain embodiments, the nanofiber precursor comprises one or more polymeric materials selected from the group consisting of polyacrylonitrile (PAN), polyethylene (PE), polycaprolactone (PCL), poly(ethyleneglycol) (PEG), poly(3,4-ethylenedioxythiophene) polystyrene sulfonate (PEDOT:PSS), poly(vinyl acetate) (PVAc), polyvinylidene fluoride (PVDF), nylon, para-aramid, Teflon, sink fibroin, collagen, zein, soy biopolymer, peanut biopolymer, DNA, RNA, alginate, cellulose, and lignin.

In certain embodiments, the first rotating belt and the second rotating belt move at a speed ranging from about 0.1 cm/min and about 3 m/s.

In certain embodiments, the first rotating belt and the second rotating belt move at a speed ranging from about 0.5 cm/min and about 100 cm/min.

### BRIEF DESCRIPTION OF THE DRAWINGS

The following detailed description of specific embodiments of the invention will be better understood when read in conjunction with the appended drawings. For the purpose of illustrating the invention, there are shown in the drawings specific embodiments. It should be understood, however, that the invention is not limited to the precise arrangements and instrumentalities of the embodiments shown in the drawings.

FIG. 1A is a schematic representation of a non-limiting system of the invention comprising a pair of automated tracks capable of drawing a fiber from a polymer solution and stretching the formed fiber through continuous rotation. FIG. 1B is a 3D representation of a system of the invention, as described in FIG. 1A. FIG. 1C is a set of images depicting automated track surface textures which can be utilized with the system of the invention.

FIGS. 2A-2B are schematic drawings of non-limiting systems of the invention, including a collection plate for collecting the fibers produced by the system of the invention and exemplary embodiments of the vessel containing the nanofiber precursor materials (such as, but not limited to, a polymer solution and/or melt).

FIGS. 2C-2E are schematic drawings of non-limiting systems of the invention, illustrating an embodiment wherein the vessel for delivering the formed polymer nanofiber to the belts comprises a centrifugal spinning device.

FIG. 3A is a schematic drawing of a non-limiting system of the invention showing a pair of automated track apparatuses each having four rollers and an elongated contact point.

FIG. 3B is a photograph of a system designed as shown in FIG. 3A.

FIGS. 4A and 4B are photographs of the system shown in FIG. 3B while in operation, demonstrating the use of the collection plate. The arrows point to nanofibers suspended between the first rotating belt and the second rotating belt.

FIG. 4C is a photograph showing a number of aligned nanofibers collected on the collection plate after operation of the system shown in FIGS. 3B, 4A and 4B.

FIGS. 5A-5C are SEM images of PVAc fibers formed using the system and methods of the invention.

FIGS. 5D-5F are SEM images of PAN fibers formed using the system and methods of the invention.

FIGS. 6A-6B are photographs showing aligned fibers being pulled “by-hand”, demonstrating the base principle of the devices of the invention.

FIGS. 6C-6E are a photograph and diagrams showing a device according to an embodiment of the invention.

FIGS. 7A-7B are a photograph and a diagram showing a device according to an embodiment of the invention, comprising a collection rack.

FIGS. 7C-7D are photographs of a collection rack, according to an embodiment of the invention, upon which aligned fiber mats have been deposited.

FIG. 8A comprises a schematic illustration of the fiber fabrication process via beltspinning at varying collection heights. The fibers collected at each height were imaged at different points along the length of a fiber array to analyze for fiber uniformity. FIG. 8B comprises photographs corresponding to the illustration with the fiber imaged at the Middle (Mid), Quarter (Qtr), and End portion of a fiber array. FIGS. 8C-8D show the diameter-uniformity of PU and PVAc at collection distances of 10.9 cm and 18.2 cm respectively. FIG. 8C comprises a representative SEM image of PVAc beltspun fibers at collection height of 10.9 cm. The PVAc fiber arrays were mechanically drawn and stretched from an DMF solution at polymer concentrations of 10% and 20%. FIG. 8D comprises a representative SEM image of PU beltspun fibers at collection height of 18.2 cm. The PU fiber arrays were mechanically drawn and stretched from an DMF solution at a polymer concentration of 7% and 10%. (SEM scale bar=5 μm).

FIGS. 9A-9B are a graph and a set of SEM images showing the diameter vs maximum length (see FIG. 2B) relationship for PVAc fibers made from polymeric solutions in DCM at concentrations of 10%, 20%, and 30% collected at 7.3, 14.6, 21.8 cm from the initial point of fiber formation. (SEM scale bar=5 μm).

FIGS. 10A-10B are a graph and a set of SEM images showing the diameter-concentration relationship for PU fibers made from polymeric solutions in DCM at concentrations of 7%, 10%, and 13% collected at 7.3, 14.6, 21.8 cm from the initial point of fiber formation. (SEM scale bar=5 μm).

FIG. 11 is a set of photographic images of a 3D spinning system that draws and stretches aligned nanofibers. An array of silicon pillars was added to one of the belts to pull a large array of polymer nanofibers simultaneously.

### DETAILED DESCRIPTION OF THE INVENTION

The invention provides in one aspect systems and methods for forming nanofibers and nanofiber arrays in a continuous and efficient manner, without the use of electrospinning. In certain embodiments, the systems and methods allow for simultaneous pulling and elongation of the nanofibers through the use of two rotating belts.

### Definitions

As used herein, each of the following terms has the meaning associated with it in this section.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

Generally, the nomenclature used herein and the laboratory procedures in polymer chemistry and chemical engineering are those well-known and commonly employed in the art.

As used herein, the articles “a” and “an” refer to one or to more than one (i.e., to at least one) of the grammatical object of the article. By way of example, “an element” means one element or more than one element.

As used herein, the term “about” is understood by persons of ordinary skill in the art and varies to some extent on the context in which it is used. As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

Throughout this disclosure, various aspects of the invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Systems and Devices

In one aspect, the invention provides a system for pulling-drawing nanofibers from a nanofiber precursor material through mechanical means. In certain embodiments, the system does not utilize electrospinning. In other embodiments, the system does not utilize applied voltages.

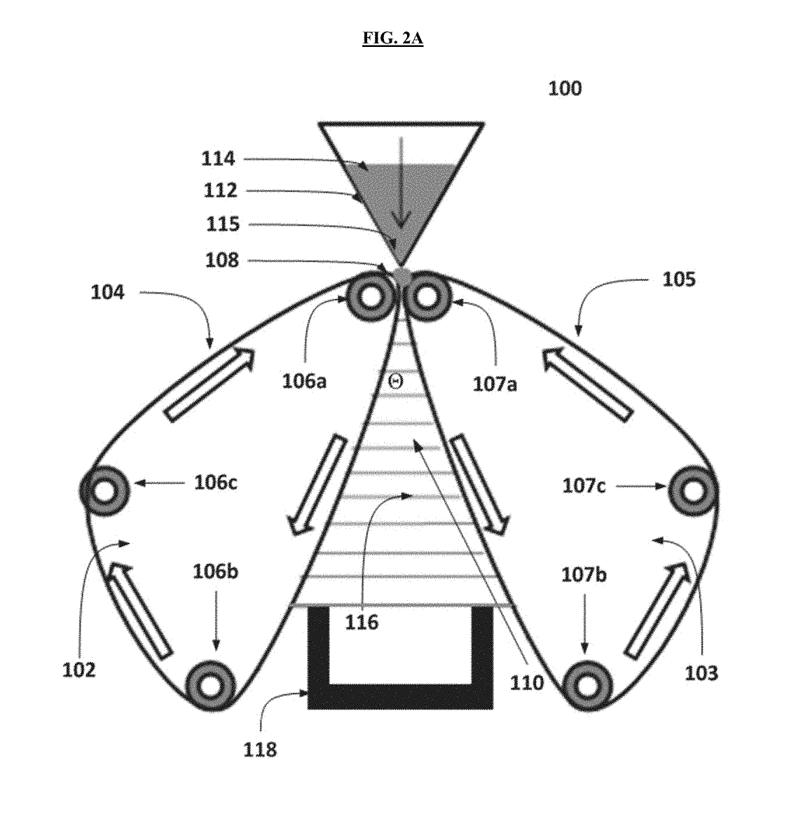

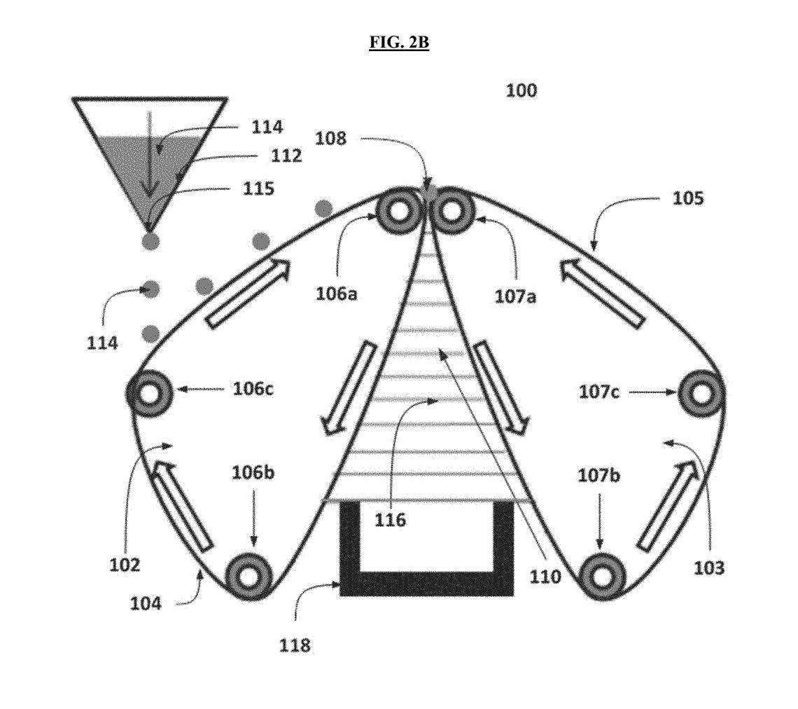

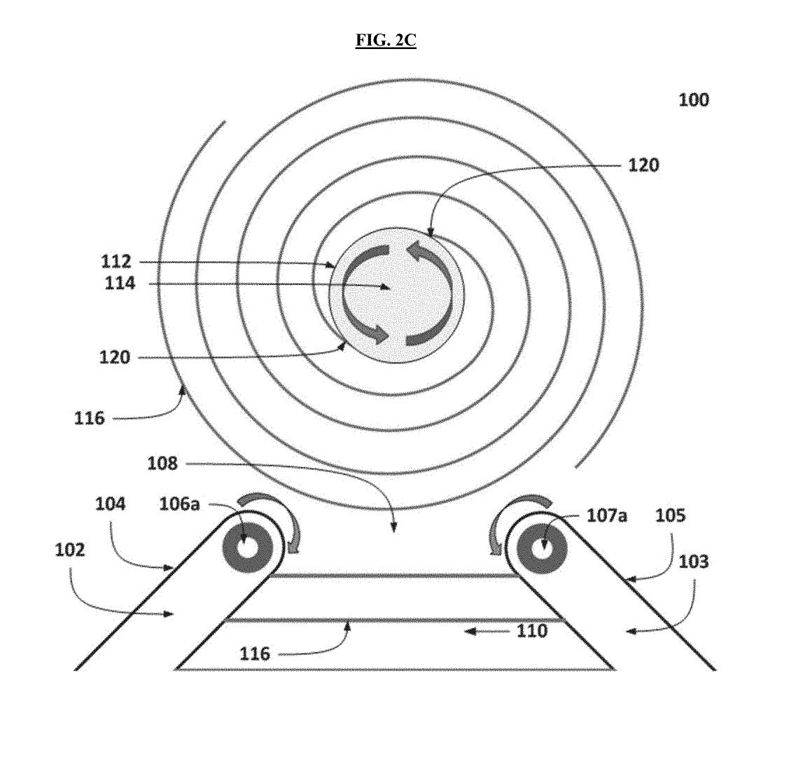

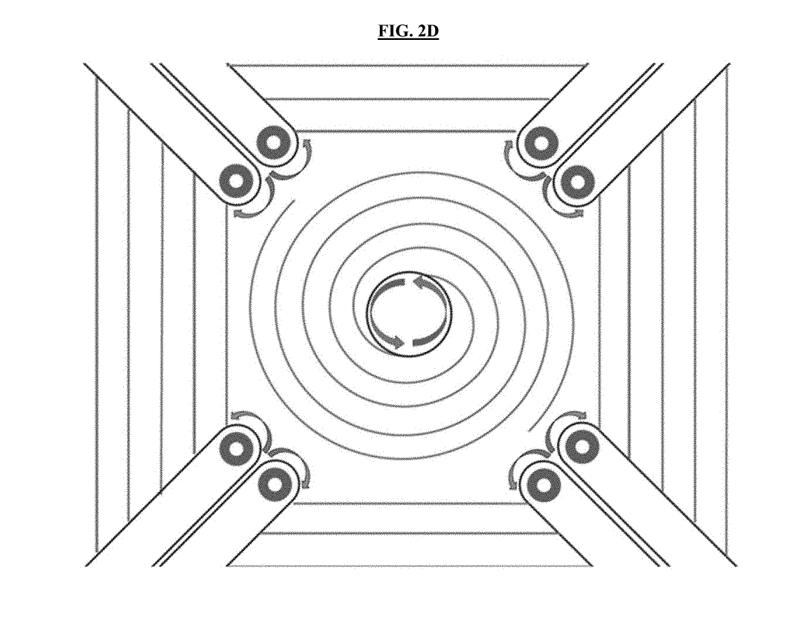

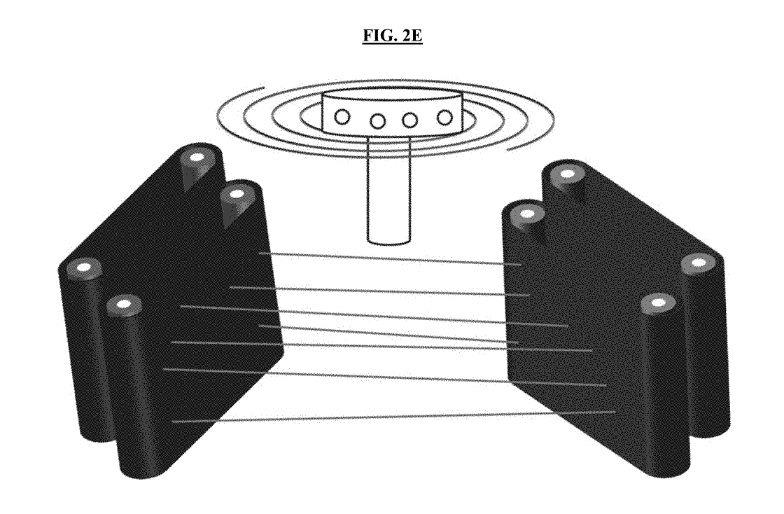

Referring now to FIGS. 2A and 2B, in certain embodiments, the system 100 comprises two automated track apparatuses 102, 103. Each automated track apparatus 102, 103 comprises a rotating belt 104, 105 and at least 2 rollers each 106a-c, 107a-c. In certain embodiments, two automated track apparatuses 102, 103 are oriented such that they define a space where a surface of rotating belt 104 is in contact, or nearly in contact, with a surface of rotating belt 105 at a point 108. In other embodiments, the two automated track apparatuses 102, 103 are oriented such that they define an internal cavity 110 below the contact point 108, bounded by the surface of the rotating belts 104, 105. In yet other embodiments, the internal cavity 110 defined by the automated track apparatuses 102, 103 is bound by the surfaces of the rotating belts 104, 105 and the contact point 108 such that the angle formed by rotating belt 104 and rotating belt 105 at point 108 is track angle θ. In yet other embodiments, the angle θ can range from about 0° to about 90°. In certain embodiments, the angle θ is variable through movement of the rollers 106a-c, 107a-c. In embodiments wherein the angle θ is about 0°, the surfaces of the rotating belts 104, 105 that define the internal cavity 110 are about parallel to one another. In other embodiments wherein the angle θ is about 90°, the surfaces of the rotating belts 104, 105 that define the internal cavity 110 are about orthogonal to one another. In certain embodiments, the contact point 108 is defined as the location where the surface of rotating belt 104 is closest to the surface of rotating belt 105, having a gap ranging, in non-limiting embodiments, from about zero or equal to zero (i.e., virtually touching each other) to tens or hundreds of centimeters (such as, for example, 1 m).

In certain embodiments, the system further comprises a vessel 112 for delivering a nanofiber precursor (such as, but not limited to, a polymer solution) 114 to the contact point 108. In certain embodiments, the vessel 112 comprises a nozzle 115 adapted and configured to deliver the nanofiber precursor 114 to the contact point 108 by a method selected from the group consisting of dripping, spraying, pouring, brushing, electrospraying and injecting. In certain embodiments, the nanofiber precursor 114 is not contacted to the contact point 108 through electrospinning. Referring now to FIG. 2A, in other embodiments, the vessel 112 and nozzle 115 define a vertical axis aligned perpendicularly to the ground, wherein the contact point 108 is aligned along the vertical axis, directly below the nozzle 115. In certain embodiments, the vessel 112 is an apparatus selected from the group consisting of a syringe, a syringe pump, a pipette, a funnel, and an extruder or an array of any of these apparatus. In alternative embodiments, the vessel 112 is a centrifugal spinning system, as illustrated in FIGS. 2C-2E.

In certain embodiments, the automated track apparatuses 102, 103 are adapted and configured to rotate the rotating belts 104, 105 around the rollers 106a-c, 107a-c in the direction indicated in FIGS. 2A-2B by the arrows. In other embodiments, the rotating belts 104, 105 rotate in a downward motion, away from the contact point 108, downward into internal cavity 110. As nanofiber precursor 114 contacts contact point 108, the nanofiber precursor 114 adheres to the surface of both rotating belt 104 and rotating belt 105. The rotating belts 104, 105 then carry the nanofiber precursor 114 into the internal cavity 110, forming nanofibers 116 that span between the rotating belts 104, 105. In certain embodiments wherein angle θ is greater than 0°, the surfaces of the rotating belts 104, 105 move away from one another within the internal cavity 110, thereby stretching and elongating the nanofibers 116. Elongation refers to the stretching or post-drawing of a nanofiber 116 that is moving with the rotating belts 104, 105 and the stretching occurs in a direction that is perpendicular to the movement of the nanofiber 116 in the internal cavity 110. Due to the motion of the rotating belts 104, 105, successively formed nanofibers 116 are aligned, spaced apart from one another and elongated within the internal cavity 110. In certain embodiments, the system further comprises a collection rack 118 nanofibers 116 that is disposed within the internal cavity 110, distal to the contact point 108, adapted and configured to remove nanofibers from the rotating belts 104, 105. In certain embodiments, the nanofibers 116 are collected on the collection rack 118. In other embodiments, the nanofibers 116 are collected on the collection rack 118 such that the nanofibers 116 are aligned with one another. In certain embodiments, the distance between the rotating belts 104, 105, at the point where the collection rack removes the nanofiber, is greater than about 1 cm. In yet other embodiments, the rotating belts 104, 105 can reach a point where they maintain a constant distance between, halting the post-drawing elongation process while continuing to transport the suspended nanofiber.

Referring now to FIG. 2B, in certain embodiments, the vessel 112 can be placed at a point “upstream” from the contact point 108 such that the nanofiber precursor 114 is carried by the rotating belt 104, to the contact point 108 as it rotates. In other embodiments, the vessel 112 can be a reservoir comprising the nanofiber precursor 114, wherein the nanofiber precursor 114 contacts rotating belt 104 such that an amount of nanofiber precursor 114 adheres to the rotating belt 104 and carries it to the contact point 108.

Referring now to FIG. 2C, in certain embodiments, the vessel 112 is a centrifugal spinning system comprising a reservoir that holds the nanofiber precursor 114 and at least one opening 120 through which the nanofiber precursor 114 can flow. In certain embodiments, the centrifugal spinning system is adapted and configured to expel nanofiber precursor at high speed as it rotates with high angular velocity, such that nanofibers 116 are formed and propelled towards the contact point 108. In other embodiments, the centrifugal spinning system rotates at an angular velocity of about 3 cm/sec to about 133 cm/sec. Referring now to FIG. 2D, in certain embodiments, the vessel 112 is a centrifugal spinning system surrounded by two or more automated track apparatuses having two or more contact points 108, such that the amount of nanofibers 116 collected are maximized. In certain embodiments, the system 100 comprising a centrifugal spinning system is oriented such that the rotational axis of the centrifugal spinning system is oriented vertically. In other embodiments, the system is oriented such that the at least one contact point 108 and the at least one opening 120 define a horizontal axis/plane, such that the automated track apparatuses draw the nanofibers 116 away from the centrifugal spinning system in a horizontal direction.

In certain embodiments, the invention further contemplates an array of track systems surrounding the centrifugal spinning device, wherein the array collects and draws separate fiber arrays. In other embodiments, the formed polymer nanofiber adheres to opposing tracks, spanning the gap between them.

In certain embodiments, the fiber orientation is orthogonal to the track orientation, and the fiber formed by centrifugal spinning can be post drawn by the angled tracks after collection.

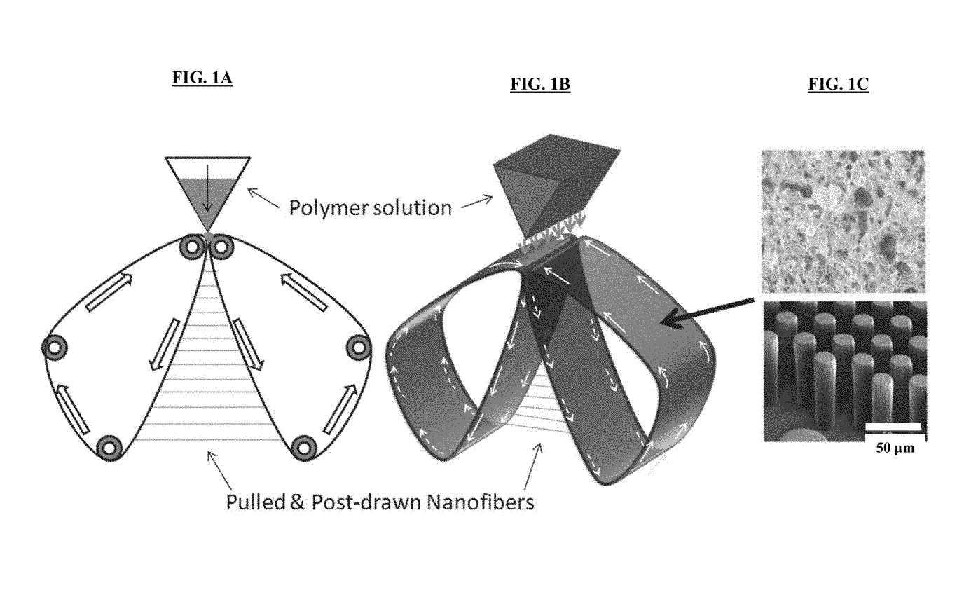

In certain embodiments, the system 100 allows for the simultaneous formation of two or more nanofibers, as depicted in FIGS. 2A-2E. In certain embodiments, as a first nanofiber 116 moves away from the contact point 108 through the motion of the rotating belts 104, 105, a second nanofiber is formed at the contact point 108. This allows the system to operate continuously to produce a multitude of aligned nanofibers. In certain embodiments, wide tracks (such as those shown in FIG. 1B) can be used to form many nanofibers at the same time in a single horizontal plane across the width of each belt.

In certain embodiments, the automated track apparatuses 102, 103 are belt driven systems powered by a motor, such as but not limited to DC motors and NEMA stepper motors. In other embodiments, the automated track apparatuses 102, 103 are hand driven or manually powered. In yet other embodiments, the automated track apparatuses 102, 103 are driven through one or more of the rollers 106a-c, 107a-c.

In certain embodiments, the nanofiber precursor 114 is a material selected from the group consisting of polymer solutions, polymer melts. In other embodiments, the nanofiber precursor 114 can be any polymer material known in the art that can be dissolved into a solution or melted to a moldable state. In other embodiments, the nanofiber precursor 114 comprises one or more polymeric materials selected from the group consisting of polyacrylonitrile (PAN), polyethylene (PE), polycaprolactone (PCL), poly(ethyleneglycol) (PEG), poly(3,4-ethylenedioxythiophene) polystyrene sulfonate (PEDOT:PSS), poly(vinyl acetate) (PVAc), polyvinylidene fluoride (PVDF), nylon, para-aramid, Teflon, silk fibroin, collagen, zein, soy biopolymer, peanut biopolymer, DNA, RNA, alginate, cellulose, lignin, and any other synthetic polymers, peptides, biopolymers, and polymeric carbohydrates known in the art.

In certain embodiments, the length and elongation/draw ratio (percentage of expansion of the fiber in length) of the nanofibers 116 can be independently controlled by adjusting one or more parameters of the system 100. In certain embodiments, the rate of rotation of the rotating belts 104, 105 are independently modifiable. In other embodiments, the angle θ is modifiable.

In yet other embodiments, the position of the automated track apparatuses 102, 103 is modifiable. In certain embodiments, the one or more parameters are adjusted by modifying the placement and/or rotation speed of the rollers 106a-c, 107a-c.

In one embodiment, the draw ratio ranges from about 1% to about 2000% (i.e. 20×). In another embodiment, the draw ratio is selected from the group consisting of about 4000%, about 8000%, about 10,000% and about 20,000%. The draw rate could be in a wide range, such as 0-1000% elongation per second. In one embodiment, the speed of the belt(s) may be in the range between about 0.1 cm/min and about 3 m/s. In another embodiment, the speed of the belt may be between about 0.5 cm/min and about 100 cm/min.

In certain embodiments, the system further comprises a means of temperature control, allowing for fabrication of materials at optimal conditions. For example, for fabricating carbon fiber, the process may use temperatures up to 3,000° C. and it may be of interest for some applications to stretch at reduced temperatures <0° C.

In certain embodiments, the rotating belts 104, 105 comprise at least one material selected from the group consisting of rubbers, plastics, ceramics, and metals. In other embodiments, the rotating belts 104, 105 are not conductive collective surfaces. In yet other embodiments, the rotating belts 104, 105 do not carry an electrical potential. In yet other embodiments, the rotating belts 104, 105 have a patterned textured surface. In yet other embodiments, the textured surface is selected from the group consisting of sponges, holes, brushes, bristles, and pillars, wherein the textured surface is either regularly or irregularly shaped and made from the same or a different material as the belts themselves. In yet other embodiments, the surface of the rotating belts is at least partially chemically modified. In yet other embodiments, the surface of the rotating belts is at least partially coated.

Methods

The invention further provides methods of forming an array of aligned nanofibers using the system of the invention.

In certain embodiments, the method comprises contacting a nanofiber precursor to a contact point defined by a first rotating belt and a second rotating belt. In other embodiments, the contact point is where the first rotating belt and the second rotating belt are in contact or are nearly in contact. In yet other embodiments, the nanofiber precursor adheres to both first rotating belt and the second rotating belt. In yet other embodiments, the method further comprises moving the first rotating belt and the second rotating belt such that the nanofiber precursor is moved away from the contact point and into an internal cavity defined by the contact point, the first rotating belt and the second rotating belt. In yet other embodiments, the nanofiber precursor forms a linear nanofiber having one end adhered to the first rotating belt and the opposite end adhered to the second rotating belt.

In certain embodiments, the first rotating belt, the contact point and the second rotating belt are disposed such that they form an angle θ. In other embodiments, wherein angle θ is greater than 0°, the linear nanofiber is elongated and stretched as it moves through the internal cavity.

In certain embodiments, the nanofiber precursor is contacted to the contact point from a vessel comprising the nanofiber precursor by a method selected from the group consisting of dripping, spraying, pouring, brushing, electrospraying, centrifugal propulsion and injecting. In other embodiments, the nanofiber precursor is not contacted to the contact point from the vessel using electrospinning.

In certain embodiments, the nanofiber is deposited on a collection rack disposed within the internal cavity.

In certain embodiments, the method of the invention further comprises repeating the prior steps in order to form two or more nanofibers. In other embodiments, the two or more nanofibers are deposited on a collection rack disposed within the internal cavity, such that the deposited nanofibers are aligned with one another. In yet other embodiments, the two or more nanofibers are deposited on a collection rack disposed within the internal cavity, such that the nanofibers are deposited to form an array having a desired geometry.

In certain embodiments, the first rotating belt and the second rotating belt move at a speed of about 0.1 cm/min to about 3 m/s.

In certain embodiments, the method can be used to form nanofibers having a length of about 0.1 mm to about 100 cm. In other embodiments, the method can be used to form nanofibers having a cross-sectional area of about 2×10¹⁵ m² to about 2×10⁻⁹ m².

In certain embodiments, the method does not comprise electrospinning. In other embodiments, the method does not comprise the use of conductive collection surfaces to which a potential is applied.

In certain embodiments, the nanofiber precursor is a material selected from the group consisting of polymer solutions, polymer melts. In other embodiments, the nanofiber precursor can be any polymer material known in the art that can be dissolved into a solution or melted to a moldable state. In other embodiments, the nanofiber precursor comprises one or more polymeric materials selected from the group consisting of polyacrylonitrile (PAN), polyethylene (PE), polycaprolactone (PCL), poly(ethyleneglycol) (PEG), poly(3,4-ethylenedioxythiophene) polystyrene sulfonate (PEDOT:PSS), poly(vinyl acetate) (PVAc), polyvinylidene fluoride (PVDF), nylon, para-aramid, Teflon, silk fibroin, collagen, zein, soy biopolymer, peanut biopolymer, DNA, RNA, alginate, cellulose, lignin, and any other synthetic polymers, peptides, biopolymers, and polymeric carbohydrates known in the art.

In certain embodiments, the configurations of the system may be adjusted to accommodate temperature and solvent evaporation requirements in fabricating different materials, so that advanced nanofiber materials with enhanced properties, such as mechanical, piezoelectric, electrical and/or thermal performance can be produced.

### Disclosure

The present invention provides a rapid and simple method to fabricate PVAc and PU nanofibers from a polymer solution by using an automated, one-step drawing device. The beltspinning methods of the invention have the potential to be employed in the fabrication of fibers with diameters ranging from hundreds of nanometers to a few micrometers. As exemplified elsewhere herein, the diameter of fibers prepared with this method were as small as 400 nm. Modifications of the operating parameters disclosed herein can lead to a considerable change in the fiber morphology. Various polymer concentrations and draw rates can be used to modify the properties of the resulting fibers.

The advanced manufacturing of fiber constructs requires the ability to tune network composition, orientation, and structure under ambient conditions using minimal processing parameters. Numerous attempts have been made by researchers to produce aligned nanofibers using electrospinning. The formation of aligned fibers using electrospinning technology also has certain limitations; with increasing thickness of the mat, the alignment of fibers is lost due to the presence of residual charge present on the fibers which hinders further deposition. However, the most severe drawback of electrospinning is that the production rate is often very low. An alternative to electrospinning methods is mechanical stretching. Prior methods of mechanical stretching include the use of sharp tungsten tips, tipless atomic force microscope (AFM) cantilevers, glass micropipettes, metal syringe needles, or the like, to draw fibers from polymer solutions or heated gels. All such methods reported in the art are serial methods and are not scalable.

In contrast, the beltspinning methods of the invention have several advantages in comparison with other nanofiber fabrication methods: (a) the technique does not require high-voltage electric fields, (b) the apparatus is inexpensive and simple to implement, (c) nanofiber structures can be fabricated into an aligned 3D structure or any arbitrary shape by varying the collector geometry, (d) uniform fiber diameters can be manipulated by altering the process variables, (e) fiber fabrication is independent of solution conductivity, (f) the method is applicable to polymer emulsions and suspensions, and (g) fibers are simultaneously created and post-drawn in one process.

The beltspinning process is independent of the solution dielectric properties and requires no high voltages in contrast to electrospinning techniques. Therefore, this method is, in theory, universally applicable to any kinds of polymers and solvents. The technique can also be used for the fabrication of composite fibers that contain magnetic or conductive nanoparticles for a wide variety of applications, since nanofibers can be spun without magnetic and electrical inference and in highly viscous solutions. In addition to the composite materials and nanoparticles, a variety of ceramics can also be processed into well-aligned nanofibers which can exhibited significantly-improved thermal and mechanical properties. The systems of the invention can be assembled inexpensively and the systems can be widely adapted to accommodate various fiber forming methods. The devices of the invention are versatile and can include interchangeable tracks In certain embodiments, the tracks can be disposable or lined with a disposable lining as a single-use device for bioengineering labs and health care providers. The device can be set up to draw single nanofibers or multi-filament arrays of nanofibers from polymer solutions or melts depending on the belt type. The belt system can be brushless, treadless, embedded with brushes, or incorporated with variously patterned treads. Adding an array of embedded brushes on the belt composed of numerous filaments or using an array of patterned treads on the belt can easily be used to scale up the fiber drawing to spin kilometers of nanofibers per minute.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that, wherever values and ranges are provided herein, the description in range format is merely for convenience and brevity and should not be construed as an inflexible limitation on the scope of the invention. Accordingly, all values and ranges encompassed by these values and ranges are meant to be encompassed within the scope of the present invention. Moreover, all values that fall within these ranges, as well as the upper or lower limits of a range of values, are also contemplated by the present application. The description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

The following examples further illustrate aspects of the present invention. However, they are in no way a limitation of the teachings or disclosure of the present invention as set forth herein.

### EXAMPLES

The invention is now described with reference to the following Examples. These Examples are provided for the purpose of illustration only, and the invention is not limited to these Examples, but rather encompasses all variations that are evident as a result of the teachings provided herein.

### Materials and Methods

### Polymer Solution Preparation

All chemicals were used as received without further purification. Polyvinyl acetate (PVAc) (500 kDa, Acros Organics, NJ, USA) was dissolved at room temperature in dimethylformamide (DMF) (Acros Organics, NJ, USA) with varying wt./vol. concentrations (from 10 wt to 30 wt %). Tecoflex™ SG-80A aliphatic polyether-based thermoplastic polyurethanes (PU) (Lubrizol Corporation, OH, USA) were dissolved in DMF with varying wt % concentrations (from 7 wt to 13 wt %). A total of six solutions were prepared by dissolving PVAc beads in DMF at 10 wt %, 20 wt %, and 30 wt % and PU pellets in DMF at 7 wt %, 10 wt %, and 13 wt %, followed by magnetic stirring for 24 h to prepare homogenous solution. The spinning process was performed at a temperature of 15-18° C. and a relative humidity of 20-25%. Using a syringe pump (New Era Pump Systems, Inc., NE-1000 Programmable Single Syringe Pump), the viscous polymer solutions were pumped and dispensed onto a system of the invention.

### Device Design

The device is an automated set-up for drawing single nanofibers or multi-filament arrays of nanofibers from polymer solutions or melts using rotating belts. Fibers are continuously spun by draw/contact spinning between two belts. The mechanical force applied during the belt spinning process produces a uniaxial orientation of fibers in the stretching direction where the polymer matrix made contact. Unlike collecting fibers along a circular axis (such cylinders and cubes) seen in many techniques in the art, the automated track system of the invention can produce continuously aligned single filament nanofibers or arrays of nanofibers along a single linear axis as fibers are suspended over the gap between the belts, which allows for the addition or option of a secondary post-drawing step at the collector stage. The automated track system has two belts which are adjustable and can be angled so polymer solutions and melts can come into contact and be manually pulled and elongated over a wide range of fiber diameters. To dispense the polymer solutions between the two belts, 5-mL syringes were filled and pumped through a 21-gauge stainless steel needle onto the rotating tracks. As the tracks touch, the extruded solution droplets on the belts are distributed and liquid polymer bridges between to form. As the two belts proceed down the track simultaneously in one direction, the polymer bridges are farther drawn allowing the fiber chains to be elongated and aligned in one direction. The device has two NEMA 17 stepper motors at the bottom of each track rotating at equal rotation speed in opposite directions to move the belts at a linear speed of 200 mm per minute. Fibers were collected onto a 4 inch wide acrylic collection tray in an aligned configuration at varying collection distances from the point of contact between the tracks and initial fiber formation. Samples at each collection distance were collected (50, 100, 150, 200, 250, 300, and 350 mm) at a fixed angle of θ=40°. Based on the device geometry, the collection distances (50, 100, 150, 200, 250, 300, and 350 mm) were associated with final fiber lengths of (36, 73, 109, 146, 182, 218, and 255 mm), respectively. The setup was contained in a cardboard box to act as an environment control preventing interference from outside air flow. Fibers were air-dried overnight at RT before characterization.

### Fiber Characterization

The average fiber diameter and fiber alignment of collected samples were determined using an electron microscope (SEM, Phenom-World Phenom Pure). The morphology of the fibers was examined using backscattering mode. An accelerating voltage of 2 kV was maintained to prevent surface damage to the substrate. Before observation, the samples were vacuum-dried and sputter coated with gold target prior to imaging. Several areas were imaged to examine the uniformity of the fiber diameters. Fiber diameters were manually measured using image analysis software (ImageJ v 1.34, National Institutes of Health, MD, USA).

### Example 1: Nanofiber Formation—First Generation

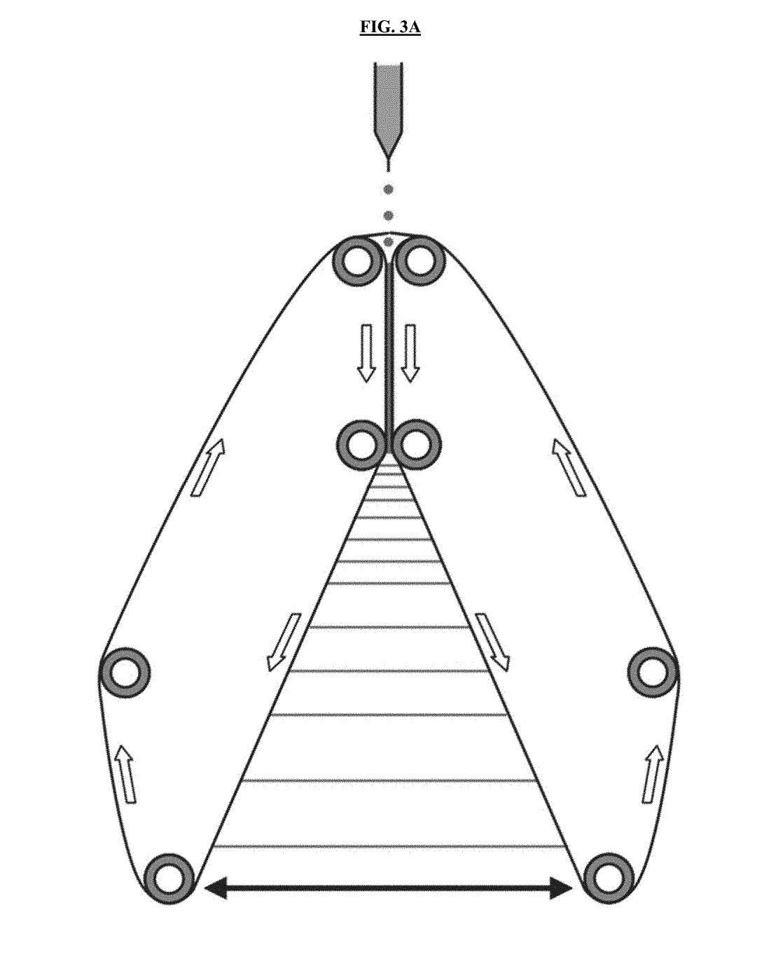

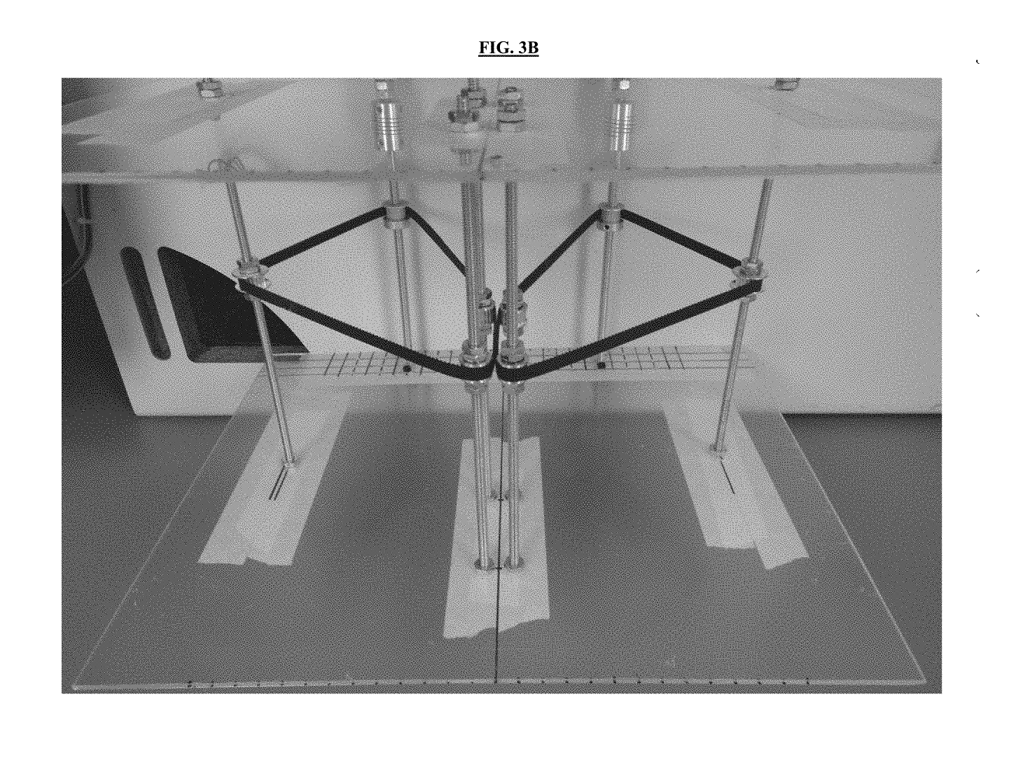

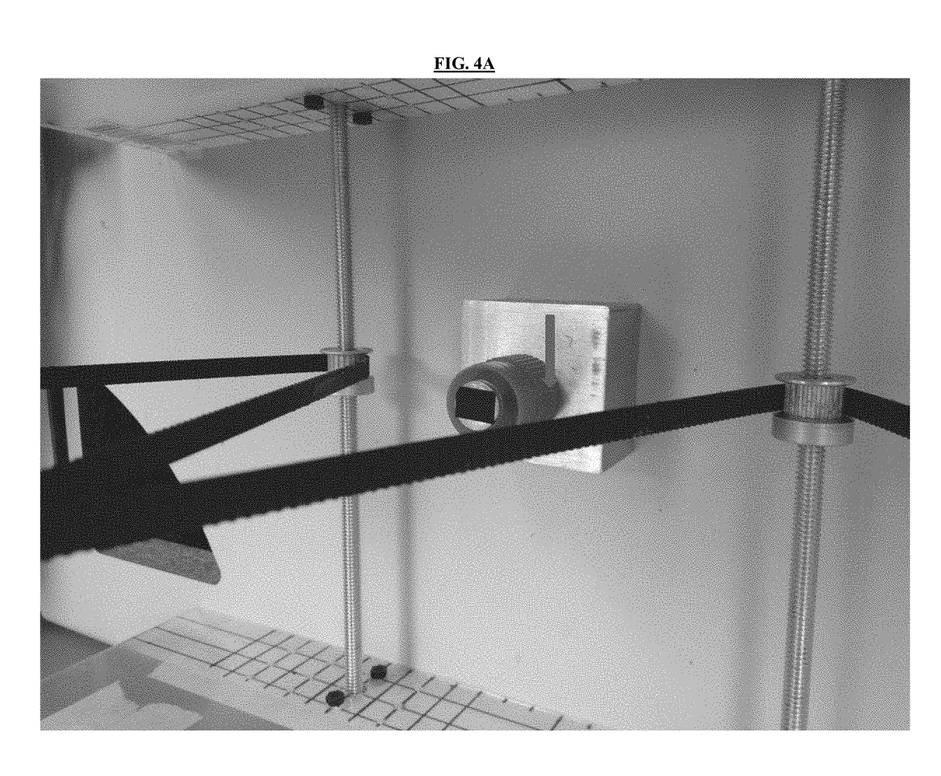

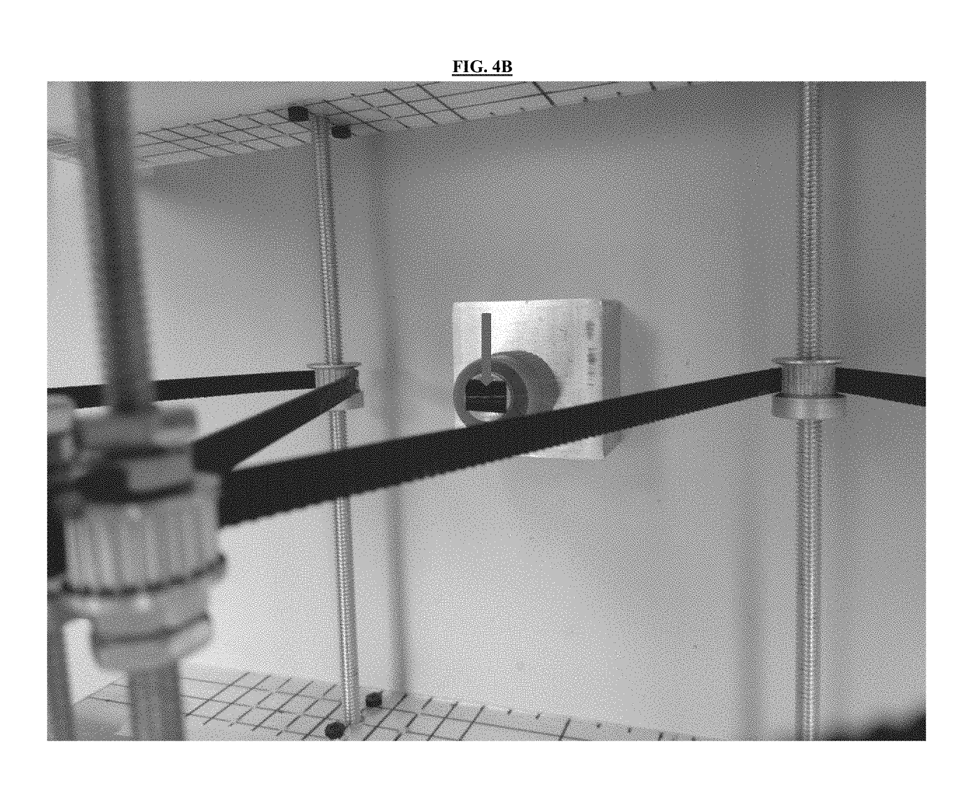

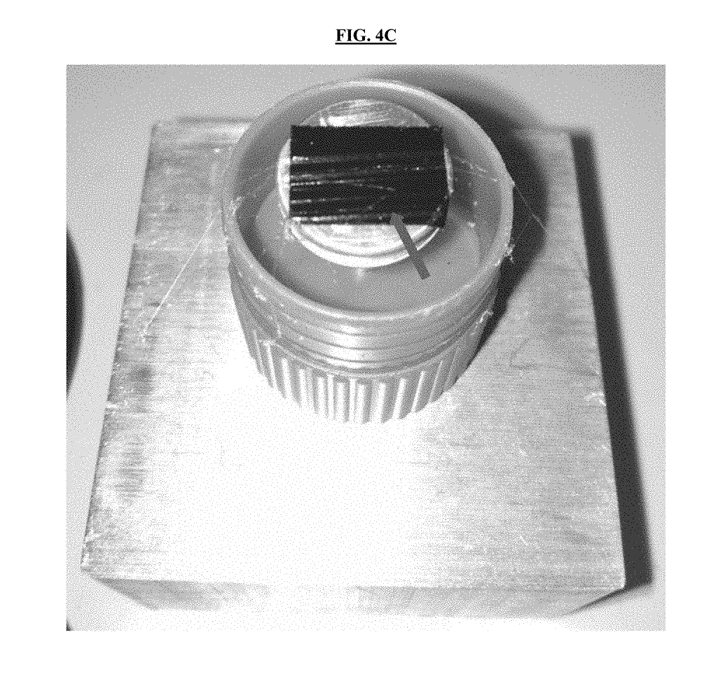

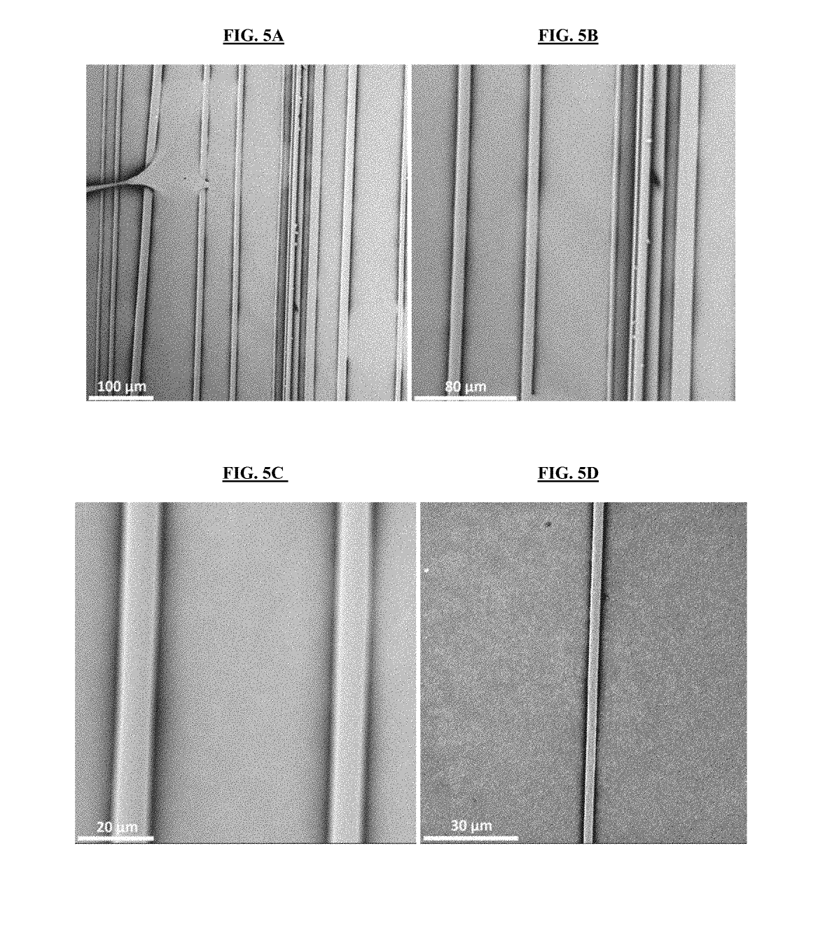

A solution pulling-drawing device of the invention was constructed according to the design shown in FIG. 3A. The device was constructed using 2 ft. long belts made of rubber suspended on four rollers and driven by stepper motors at a rate of 1 mm/s. A solution of polyvinyl acetate (PVAc) 10% in dimethylformamide (DMF) was dropped on to the belts at the contact point using a syringe as the device was rotated. Below the contact point, nanofibers formed, suspended between the belts. The fibers were elongated and deposited on the collection plate (FIGS. 4A-4C). SEM images of the fibers show that the resulting nanofibers are aligned and substantially uniform in dimension (˜10 μm in diameter) (FIGS. 5A-5C).

The device was similarly used to pull polyacrylonitrile (PAN) nanofibers from a solution of PAN 10% in dimethylformamide (DMF). SEM images also showed that the PAN fibers were well formed and substantially uniform, having an average diameter of about 3 μm (FIGS. 5D-5F).

### Example 2: Nanofiber Formation—Second Generation

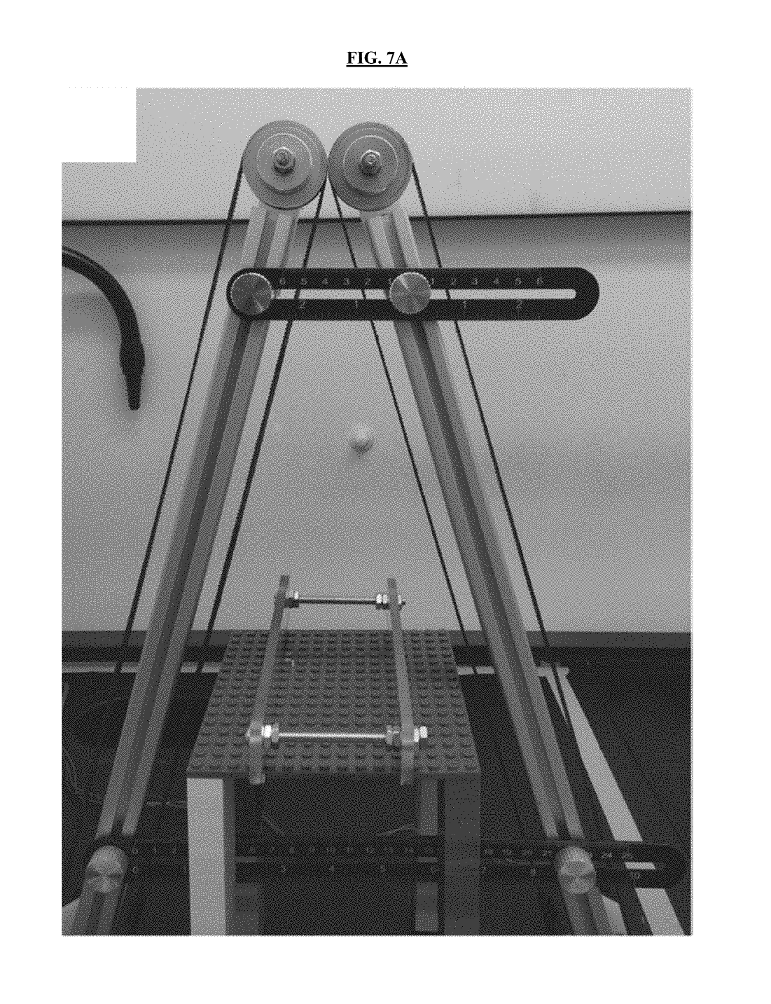

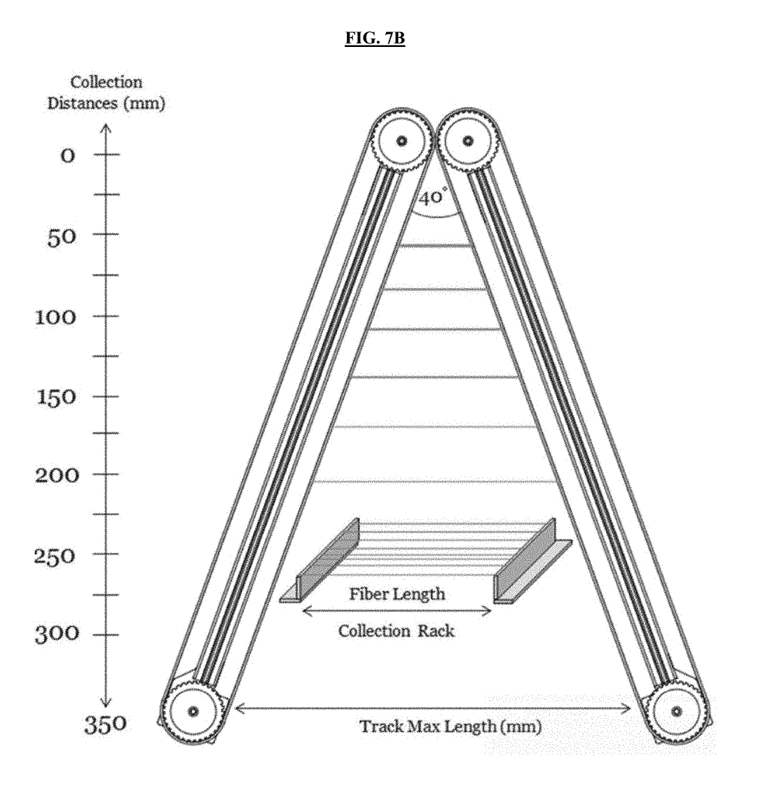

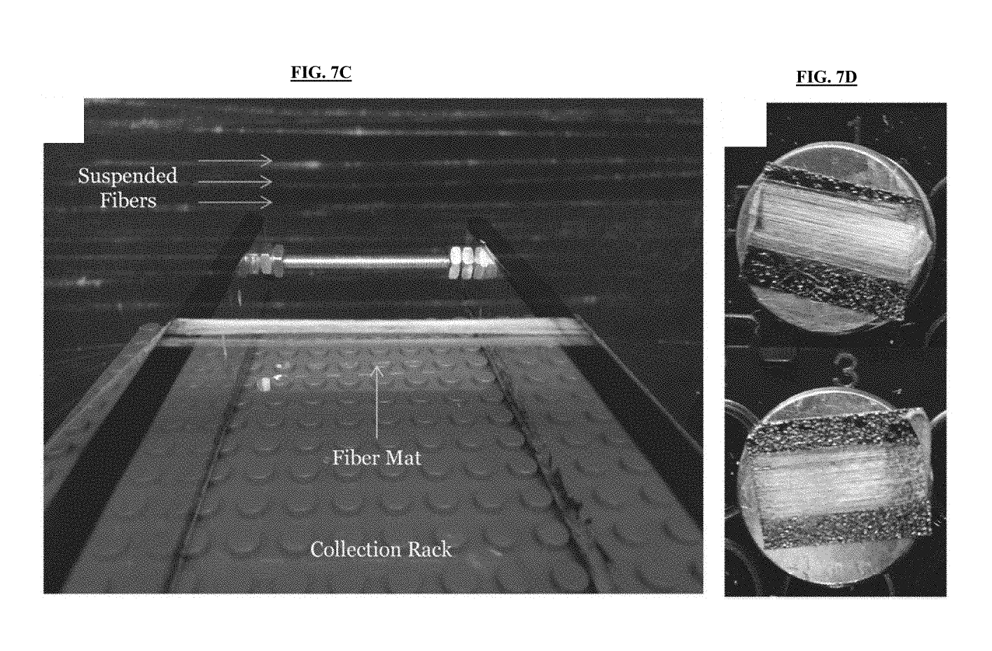

Following the methods described elsewhere herein, and as shown in FIG. 7C, fibers were successfully collected across the two plates for all parameter combinations with varying concentrations in combination with sequential collection distances. Nanoscaled fibers were obtained from the polymer solutions by the push/pull motions of the rotating touch belts. The belt spinning has several exclusive processing parameters such as belt velocity, collection distance, belt area, and solution supply, and so forth. Here, solution supply means the supplied amount of polymer solution on the belt are fixed to be about 1.5 mL. In addition, polymer solution characteristics, such as molecular weight, solution viscosity, surface tension, and temperature can affect the spinnability and thereby the diameter, morphologies, and microstructures of the resulting spun fiber. In the experiments shown in FIG. 7B, the tracks were fixed at an angled of 40° throughout the study with a belt velocity of 200 mm per minute.

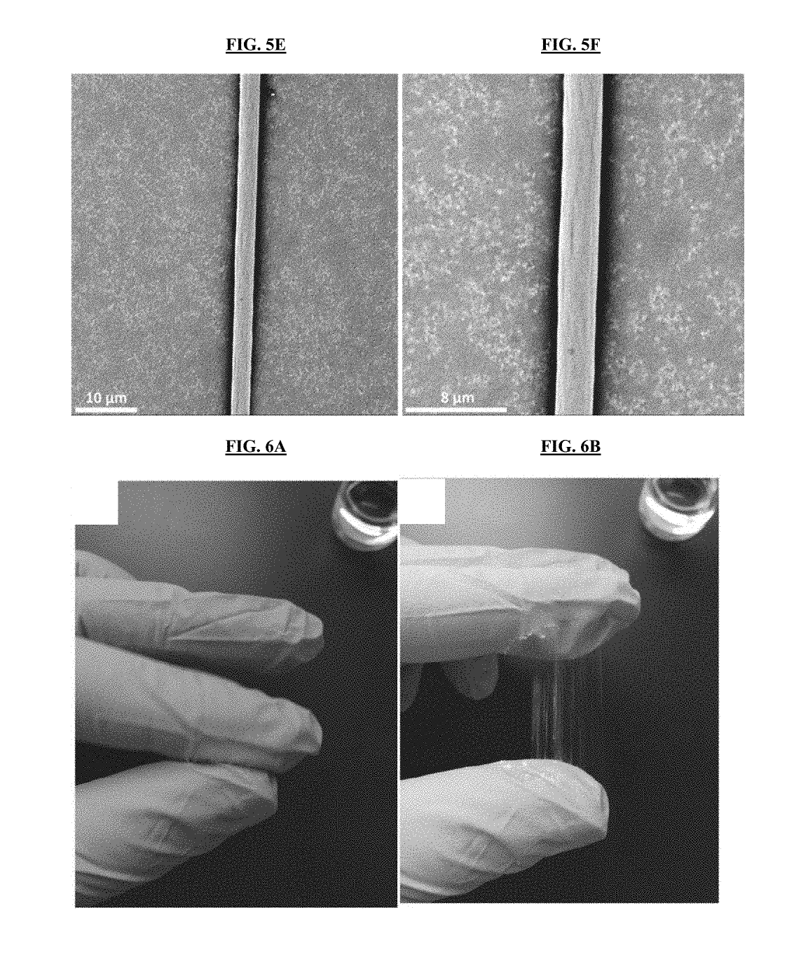

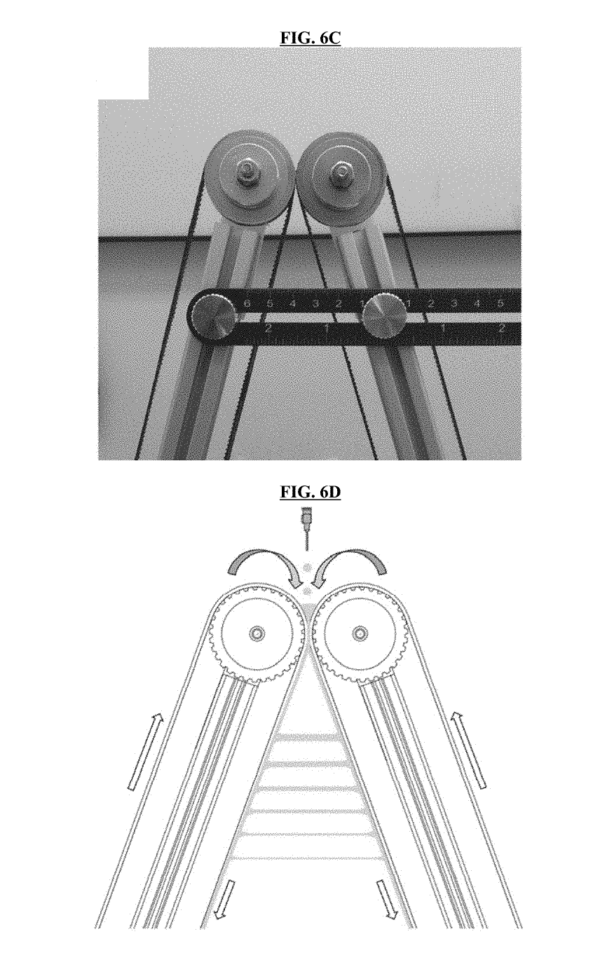

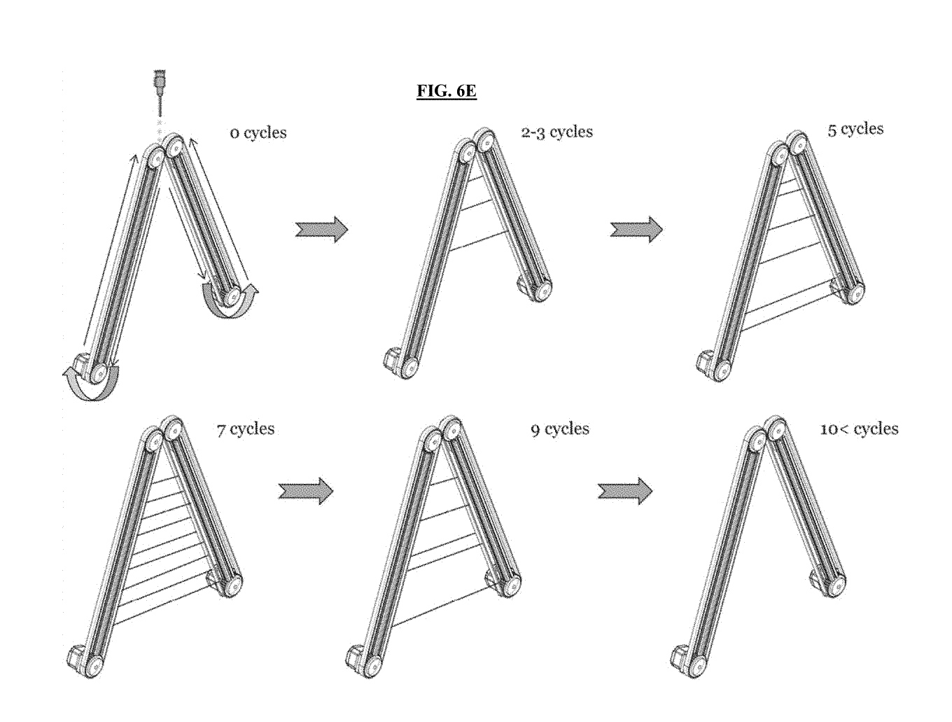

As shown in FIG. 6D, a syringe loaded with polymer solution is connected to an external pump, which resulted in an extruded polymer solution droplet at the tip of the needle. The rotating belts were brought into contact with the spread solution droplets, thus pulling out a single filament. In the beginning of the process, the device cycled through 2-3 times to allow the polymer solution to evaporate slightly before fiber forming conditions were optimal for fiber drawing (see FIG. 6E). After sufficient time was allowed for the polymer solution to evaporate as the solution filament moved down the track, the drying and stretching process caused an increase in molecular entanglements, thereby reducing the overall deformability of the fibers. A solidified fiber was formed by rapid solvent evaporation and collected on a parallel plate rack in an aligned configuration. The manually stretched fibers were not immediately drawn, but collected around the fourth cycle as initial fiber formation began after the third cycle, once the belt drying cycles ensured sufficient time for solvent evaporation. Collection was sometimes impeded due to early fiber breakage and fibers colliding with other fibers formed below during rapid fiber formation. Fibers were also observed to fall off the plates due to collisions with other fibers. The speed of 200 mm/minute was chosen to reduce collisions and allow the polymer solutions to sufficiently evaporate to form fibers.

### Example 3: Solution Concentration and Draw Ratio Relationships

Fibers were drawn from the various pre-polymer solution concentrations described in Polymer solution preparation elsewhere herein. The starting diameters of the drawn fibers were usually on the order of a few tenths of a micrometer. In both polymers (PVAc and PU), the fibers obtained from higher concentration solutions displayed an increase in fiber diameters and fibers collected at larger fiber lengths had reduced fiber diameters. PVAc and PU were dissolved in DMF with increasing concentrations (with molecular weights of 500 and 140×10³ kDa, respectively). PVAc (10 wt % to 30 wt %) exhibited higher diameters with increase concentrations. Without intending to be limited to any particular theory, the higher concentration allowed for the formation of polymer chain entanglements to form smooth and uniform fibers. An increase in the polymer solution concentration made the polymer chains in solution more compact. The diameter of nanofibers drawn varied from 400 nm to 20 μm. Continuous fibers were successfully collected with the PVAc nanofibers with an average diameter of less than 3.5 μm at lengths up to 455 mm (at a collection height of 350 mm), and PVAc nanofibers with an average diameter of less than 12.2 μm were collected at lengths up to 36.4 cm (at a collection height of 50 cm). At 30 wt % solution, PVAc fibers had an average diameter of 3.1±1.6 μm at max length of 36 mm. Compared to 500 Da PVAc, PU fibers were prepared from a 140,000 Da polymer. Because of the much higher molecular weight of the PU, the viscosity and corresponding fiber diameter of the 10 wt. % PU solutions was higher than the fibers spun from 10 wt. % PVAc solution (6.1±1.3 μm vs. 4.0±1.9 μm). The PU fibers still followed the trend observed in the PVAc fibers, where a higher viscosity resulted in greater fiber diameter. The PU used was found to be insoluble above ca. 15 wt %. At concentrations high above 15%, the viscosity of the PU solution was very high and hard mix uniformly. The diameter of nanofibers drawn varied from 600 nm to 10 Continuous fibers were successfully collected with the PU nanofibers with an average diameter of less than 3.5 μm at lengths up to 45.5 cm (at a collection height of 350 mm), and PU nanofibers with an average diameter of less than 12.2 μm were collected at lengths up to 36.4 cm (at a collection distance 50 cm).

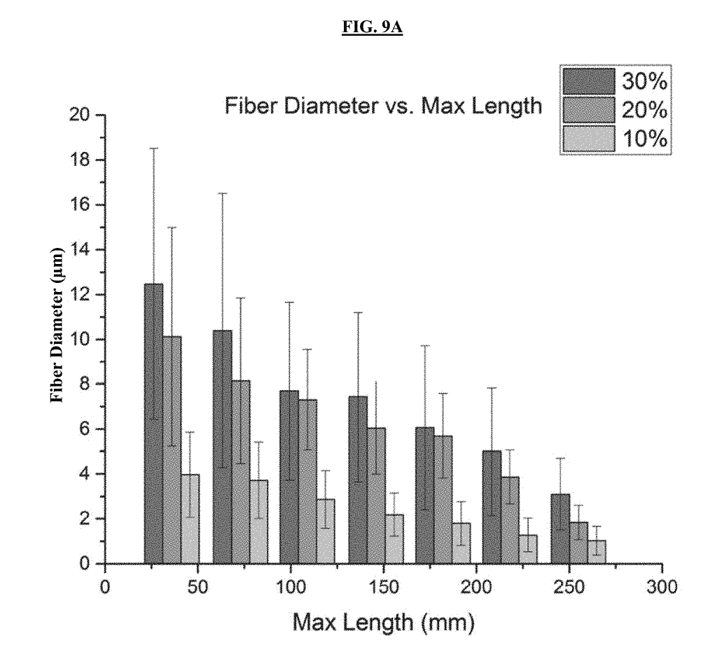

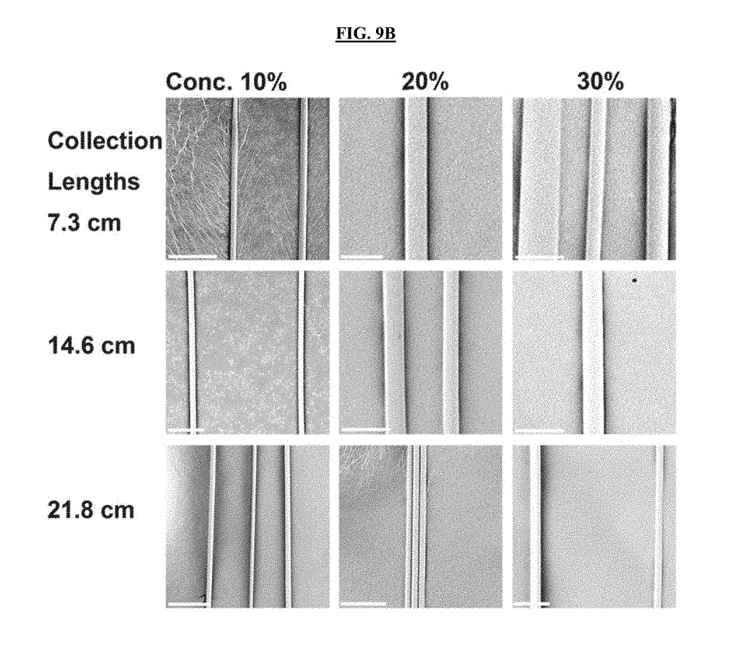

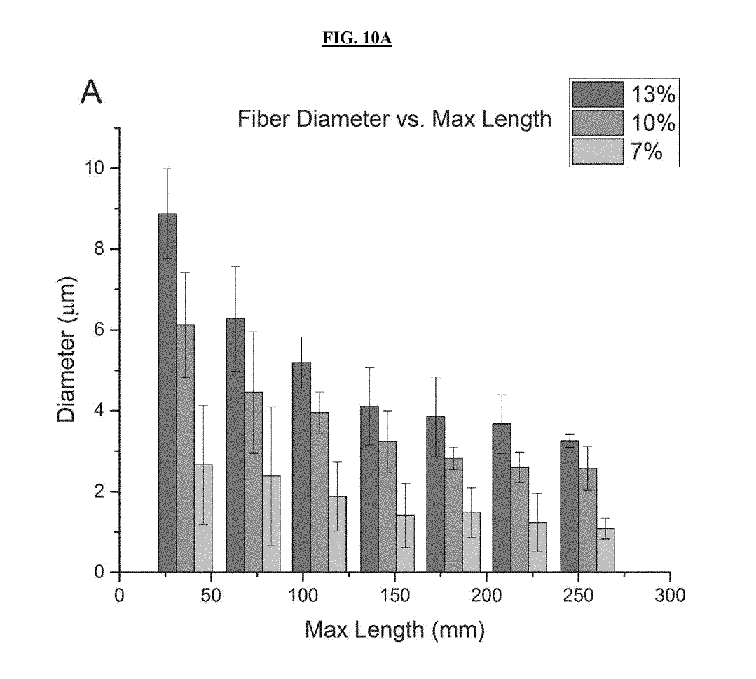

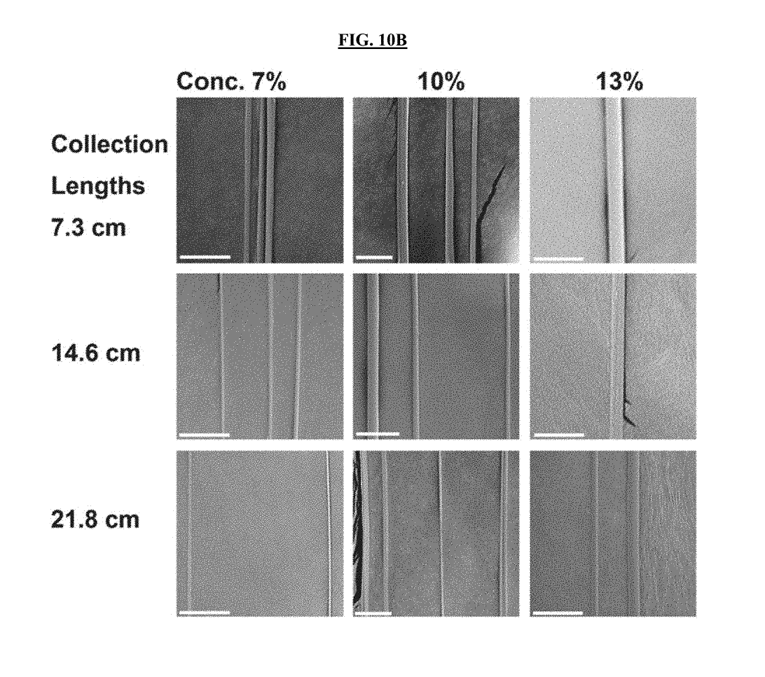

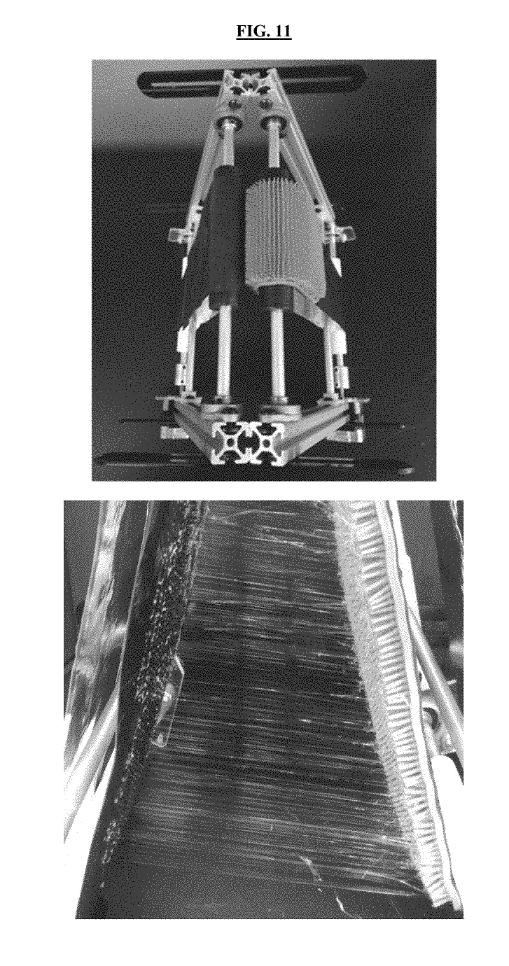

High aspect ratio fibers of long lengths (cm scale) with diameters ranging from sub-100 nm to microns were obtained by adjusting the processing parameters (collection height of the substrate) and material parameters (polymer solution concentration). FIG. 9B shows SEM images of fibers formed from PVAc solutions of various concentrations (10-30 wt %), with diameters ranging from 1.0±0.64 to 12.5±6.0 μm. The fibers formed from the 30 wt % solution appeared to have a larger starting diameter, whereas those formed from lower concentration solutions were smaller, which in most cases also served to reduce the final fiber diameters. PVAc fibers prepared showed no beading or wavy morphology. FIG. 10B shows fibers formed from PU solutions ranging from 7 to 13 wt %. Fiber diameters varied from 1.1±0.3 to 8.8±1.1 μm. At all concentrations tested, no beading or wavy morphology were observed. The solution viscosity increased with concentration. Fibers formed from the 13 wt % solution had a larger starting diameter than fibers from the 7 wt % solution. The trend was found to be essentially linear until the critical entanglement concentration was reached. Above this concentration, the viscosity increased exponentially with concentration. Using the PU 7 wt % solutions, FIG. 7C shows how fiber mats can be made and tested. The fibers collected were extremely flexible and were easily removed from the collecting rack without tearing.

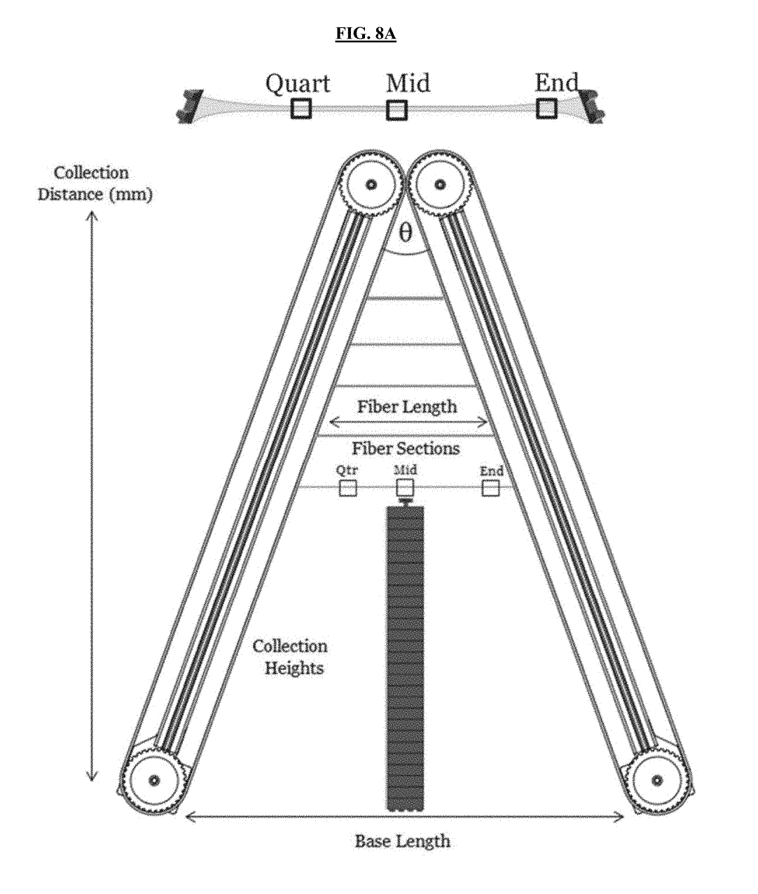

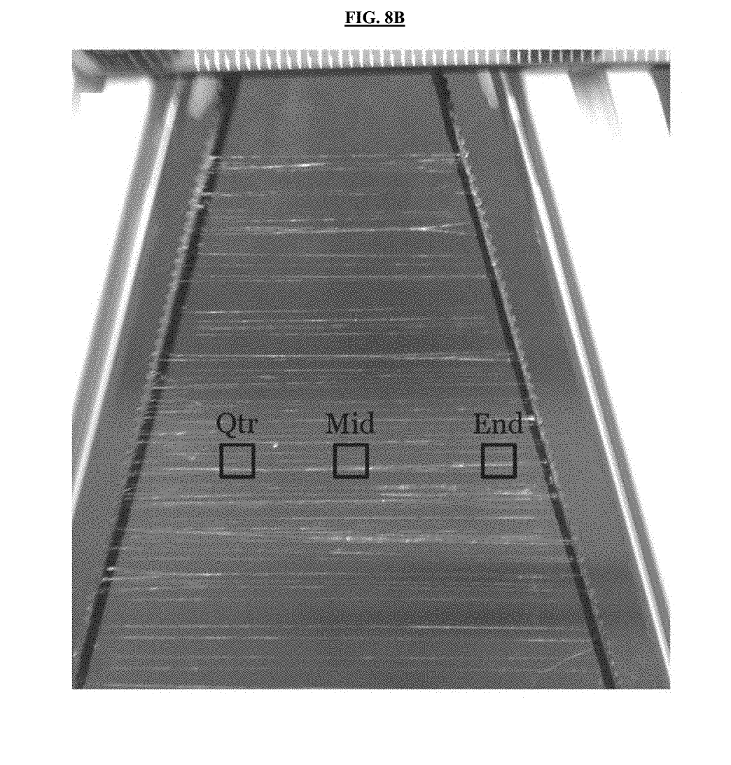

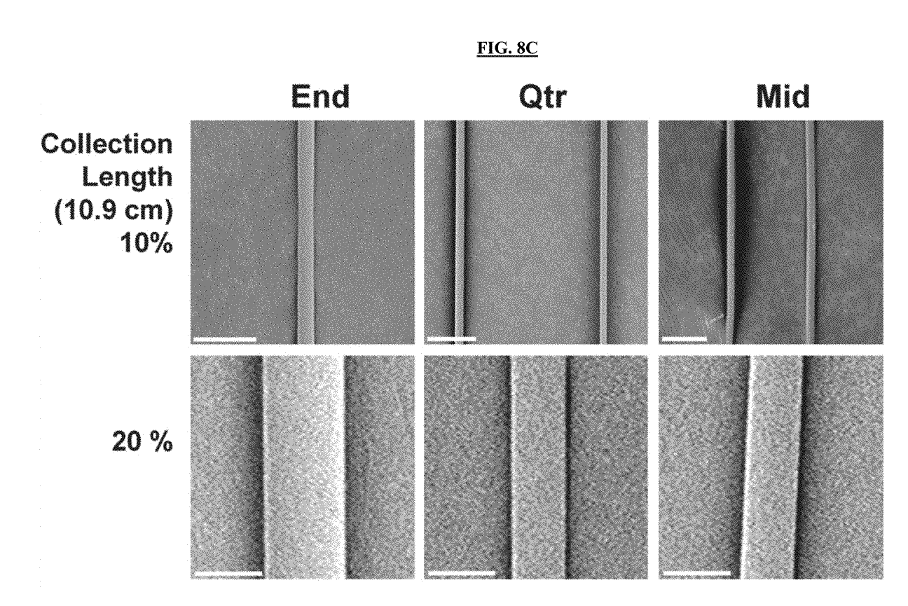

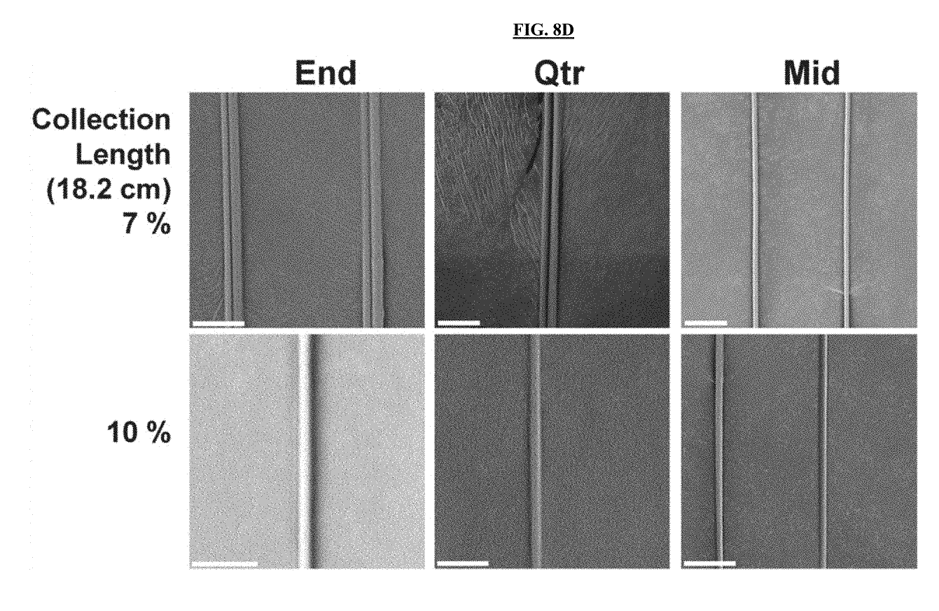

To test fiber uniformity (and processability), fiber diameters were measured at different sections of the fiber. As depicted in FIG. 8A, the fibers were sectioned, as Middle (Mid), Quarter (Qtr), and End, and collected on SEM stubs at different collection distances. The morphology of PVAc and PU fiber arrays were mechanically stretched and simultaneously collected onto SEM stubs at two different concentrations for two different collection distances. The resulting nanofibers exhibit the same morphology with almost the same diameter throughout the fiber length, but the End sections, which anchor and hold the fiber from breaking. As expected, the ends of fibers, near the track attachment, had a larger diameter than the Mid and Qtr section of the fiber. The diameters of the fabricated End nanofibers extracted from the SEM images in FIGS. 8C & 8D are PVAc and PU at a polymer concentration of 10% for max of length of 182 mm are 1.95±1.03 and 2.37±0.36. While, the Qtr and Mid sections had minimal change in diameter and majority of the length of fibers was uniform with average diameters of 1.62±0.7 and 1.58±0.91 for PVAc and 1.70±0.28 and 1.67±0.27 for PU. With a percent difference of less than 3%, the nanofibers are highly uniform throughout the fiber length suspended from end to end.

TABLE 1
PVAc Diameter Uniformity at Various Max Lengths

| Length (mm) | Conc. (%) | End | Qtr | Mid |
|---|---|---|---|---|
| 109 | 10 | 2.21 ± 1.32 | 1.96 ± 1.20 | 1.97 ± 1.13 |
| | 20 | 6.20 ± 2.51 | 5.80 ± 2.34 | 5.76 ± 2.25 |
| 182 | 10 | 1.95 ± 1.03 | 1.62 ± 0.97 | 1.58 ± 0.91 |
| | 20 | 4.99 ± 2.05 | 4.69 ± 1.96 | 4.67 ± 1.90 |

TABLE 2
PU Diameter Uniformity at Various Max Lengths

| Length (mm) | Conc. (%) | End | Qtr | Mid |
|---|---|---|---|---|
| 109 | 7 | 4.17 ± 0.95 | 2.90 ± 0.86 | 2.86 ± 0.83 |
| | 10 | 4.53 ± 0.59 | 3.66 ± 0.53 | 3.45 ± 0.51 |
| 182 | 7 | 2.00 ± 0.70 | 1.39 ± 0.64 | 1.38 ± 0.59 |
| | 10 | 2.37 ± 0.36 | 1.70 ± 0.28 | 1.67 ± 0.27 |

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A system for forming a nanofiber, the system comprising:
a first automated track apparatus comprising a first rotating belt spanning at least two first rollers;
a second automated track apparatus comprising a second rotating belt spanning at least two second rollers; and
a vessel containing a nanofiber precursor material;
wherein:
the first rotating belt and the second rotating belt are disposed facing each other and define a contact point where the first rotating belt and the second rotating belt are in contact with each other or are at their closest point to each other;
the first rotating belt, second rotating belt and contact point define an internal cavity where the first rotating belt and second rotating belt face each other at a distance from each other;
the first automated track apparatus is adapted and configured to rotate the first rotating belt around the at least two first rollers and the second automated track apparatus is adapted and configured to rotate the second rotating belt around the at least two second rollers, such that the first rotating belt and the second rotating belt move in the same direction away from the contact point, towards the internal cavity;
the vessel is adapted and configured to deliver the nanofiber precursor material to the contact point and the first rotating belt and the second rotating belt are adapted and configured to contact the nanofiber precursor material at the contact point such that the nanofiber precursor material adheres to the first rotating belt and the second rotating belt, such that the nanofiber precursor material spans from the first rotating belt to the second rotating belt;
the vessel does not comprise an electrospinning nozzle;
the nanofiber precursor material is not an electrospun material; and
wherein, when the first rotating belt and second rotating belt move away from the contact point, the nanofiber precursor material is carried into the internal cavity and is elongated while moving through the internal cavity, thereby forming a nanofiber.

2. The system of claim 1, wherein the angle defined by the first automated track apparatus, the contact point and the second automated track apparatus ranges from 0° to about 180°.

3. The system of claim 1, wherein the vessel comprises a nozzle adapted and configured to deliver the nanofiber precursor material to the contact point through a method selected from the group consisting of dripping, spraying, pouring, brushing, electrospraying, and injecting.

4. The system of claim 3, wherein the vessel and nozzle define a vertical axis aligned perpendicularly to the ground, wherein the contact point is aligned along the vertical axis, directly below the nozzle.

5. The system of claim 3, wherein the vessel and nozzle are adapted and configured to deliver the nanofiber precursor material to the contact point by delivering the nanofiber precursor material to the first rotating belt, the second rotating belt or both, at a point “upstream” from the contact point, such that the nanofiber precursor material is carried to the contact point as the first and second rotating belts move.

6. The system of claim 1, wherein the vessel is a reservoir adapted and configured to allow the first rotating belt, second rotating belt or both, to contact the nanofiber precursor material such that an amount of nanofiber precursor material adheres to the rotating belt and carries it to the contact point as the first and second rotating belts move.

7. The system of claim 1, further comprising a collection rack disposed within the internal cavity, distal to the contact point, adapted and configured to remove the nanofiber from the first and second rotating belts.

8. The system of claim 7, wherein the distance between the first rotating belt and the second rotating belt at the point where the collection rack removes the nanofiber is greater than about 1 cm.

9. The system of claim 1, wherein the first automated track apparatus and the second automated track apparatus are independently selected from the group consisting of a motor-powered belt driven system and a manually operated belt driven system.

10. The system of claim 1, wherein the first rotating belt is driven by at least one of the at least two first rollers and the second rotating belt is driven by at least one of the at least two second rollers.

11. The system of claim 1, wherein at least one parameter of the first automated track apparatus and the second automated track apparatus selected from the group consisting of the rotating belt movement speed, rotating belt orientation, and rotating belt location are independently modifiable.

12. The system of claim 1, wherein the first rotating belt and the second rotating belt both move at a speed ranging from about 0.1 cm/min and about 3 m/s.

13. The system of claim 1, wherein the first rotating belt and the second rotating belt independently comprise at least one of the following: (a) at least one material selected from the group consisting of rubber, plastic, ceramics, and metals; (b) a patterned textured surface independently selected from the group consisting of sponges, holes, brushes, bristles, and pillars.

14. The system of claim 1, wherein the vessel comprises a centrifugal spinning apparatus adapted and configured to rotate and extrude nanofiber precursor material towards the contact point between the first rotating belt and the second rotating belt.

15. The system of claim 14, wherein the centrifugal spinning system is oriented such that the rotational axis of the centrifugal spinning system is oriented vertically.

16. A method of forming a nanofiber, the method comprising:
contacting a nanofiber precursor to a contact point defined by a first rotating belt and a second rotating belt, the contact point being where the first rotating belt and the second rotating belt are in contact or are nearly in contact, wherein the nanofiber precursor adheres to both the first rotating belt and the second rotating belt;
moving the first rotating belt and the second rotating belt such that the nanofiber precursor is moved away from the contact point and into an internal cavity defined by the contact point, the first rotating belt and the second rotating belt, wherein the nanofiber precursor forms a linear nanofiber having one end adhered to the first rotating belt and the opposite end adhered to the second rotating belt;
wherein the nanofiber precursor is not electrospun.

17. The method of claim 16, wherein the first rotating belt, the contact point and the second rotating belt are disposed such that they form an angle greater than 0° and the linear nanofiber is elongated and stretched as it moves through the internal cavity.

18. The method of claim 16, wherein the nanofiber precursor is delivered to the contact point from a vessel comprising the nanofiber precursor by a method selected from the group consisting of dripping, spraying, pouring, brushing, electrospraying, and injecting.

19. The method of claim 16, wherein the linear nanofiber is deposited on a collection rack disposed within the internal cavity.

20. The method of claim 16, wherein at least one applies: (a) the method is repeated in order to form two or more nanofibers; (b) the method is continuous such that nanofibers are produced in a continuous manner.

21. The method of claim 20, wherein the linear nanofibers are deposited on a collection rack disposed within the internal cavity, such that (a) the deposited nanofibers are aligned with one another, or (b) the nanofibers are deposited to form an array having a desired geometry.

22. The method of claim 16, wherein the nanofiber precursor is a material selected from the group consisting of polymer solutions, polymer melts that includes any polymer that can be dissolved into a solution or melted to a moldable state.

23. The method of claim 16, wherein the nanofiber precursor comprises one or more polymeric materials selected from the group consisting of polyacrylonitrile (PAN), polyethylene (PE), polycaprolactone (PCL), poly(ethyleneglycol) (PEG), poly(3,4-ethylenedioxythiophene) polystyrene sulfonate (PEDOT:PSS), poly(vinyl acetate) (PVAc), polyvinylidene fluoride (PVDF), nylon, para-aramid, Teflon, sink fibroin, collagen, zein, soy biopolymer, peanut biopolymer, DNA, RNA, alginate, cellulose, and lignin.

24. The method of claim 19, wherein the first rotating belt and the second rotating belt move at a speed ranging from about 0.1 cm/min and about 3 m/s.
